(19) United States
(12) Patent Application Publication
(10) Pub. No.: US 2021/0299565 A1
(43) Pub. Date: Sep. 30, 2021

(54) NON-TRANSITORY COMPUTER-READABLE MEDIUM AND VIDEO GAME PROCESSING SYSTEM

(71) Applicant: SQUARE ENIX CO., LTD., Tokyo (JP)

(72) Inventors: Takamasa SHIBA, Tokyo (JP); Hiroshi KOBAYASHI, Tokyo (JP); Jun WAGA, Tokyo (JP); Yutaka YOSHIDA, Tokyo (JP)

(21) Appl. No.: 17/216,133

(22) Filed: Mar. 29, 2021

(30) Foreign Application Priority Data
Mar. 27, 2020 (JP) 2020-058480

(51) Int. Cl. A63F 13/55; A63F 13/355; A63F 13/65; A63F 13/44; A63F 13/822

(52) U.S. Cl. CPC A63F 13/55; A63F 13/355; A63F 13/822; A63F 13/44; A63F 13/65

(57) ABSTRACT

A non-transitory computer-readable medium including a video game processing program for causing a server to perform functions to control progress of a video game using positional information of a user terminal in response to a user operation is provided. The functions include: a first specifying function configured to specify at least one position in a virtual space corresponding to map information of a real space as a first position in accordance with a first rule; a second specifying function configured to specify at least one position in the virtual space as a second position in accordance with a second rule; an arranging function configured to arrange a predetermined object at the first position and/or the second position; and an occurring function configured to cause an event corresponding to an object to occur in accordance with a positional condition and a position of the arranged object.

### CROSS-REFERENCE TO RELATED APPLICATION

The present application claims priority to and the benefit of Japanese Patent Application No. 2020-058480 filed on Mar. 27, 2020, the disclosure of which is expressly incorporated herein by reference in its entirety.

### BACKGROUND

At least one of embodiments of the present disclosure relates to a non-transitory computer-readable medium including a video game processing program and a video game processing system for causing a server to perform functions to control progress of a video game using positional information of a user terminal in response to an operation of a user.

In recent years, various systems each using positional information of a user terminal have been proposed in a field of video games.

In such a system, there is one in which a control regarding occurrence of a game event is executed on the basis of positional information of a user terminal. See Japanese Patent Application Publication No. 2012-016539; hereinafter, referred to as “Patent Document 1”.

### SUMMARY

Now, in system using positional information of a user terminal, there is a system in which an object is arranged in a virtual space corresponding to map information of a real space, and an event corresponding to the object occurs in accordance with a relationship of positions in the virtual space corresponding to a position of the object and positional information of a user terminal. Here, in a case where the position at which the object is arranged in the virtual space is defined on the basis of a single rule, a position at which the object is arranged and the corresponding event occurs may become monotonous. As a result, there has been a possibility that occurrence of an event in accordance with progress of a video game also becomes monotonous and interest of a user in the video game is thus diminished.

It is an object of at least one of embodiments of the present disclosure to solve the problem described above, and to maintain interest of a user in a video game.

According to one non-limiting aspect of the present disclosure, there is provided a non-transitory computer-readable medium including a video game processing program for causing a server to perform functions to control progress of a video game using positional information of a user terminal in response to an operation of a user.

The functions include a first specifying function configured to specify at least one position in a virtual space as a first position in accordance with a first rule, the virtual space corresponding to map information of a real space.

The functions also include a second specifying function configured to specify at least one position in the virtual space as a second position in accordance with a second rule different from the first rule.

The functions also include an arranging function configured to arrange a predetermined object at any or both of the first position and the second position.

The functions also include an occurring function configured to cause an event corresponding to an object to occur in accordance with a positional condition regarding a user virtual position in the virtual space corresponding to the positional information of the user terminal and a position of the arranged object.

According to another non-limiting aspect of the present disclosure, there is provided a video game processing system for controlling progress of a video game using positional information of a user terminal in response to an operation of a user. The video game processing system includes a communication network, a server, and a user terminal.

The video game processing system includes a first specifying unit configured to specify at least one position in a virtual space as a first position in accordance with a first rule, the virtual space corresponding to map information of a real space.

The video game processing system also includes a second specifying unit configured to specify at least one position in the virtual space as a second position in accordance with a second rule different from the first rule.

The video game processing system also includes an arranging unit configured to arrange a predetermined object at any or both of the first position and the second position.

The video game processing system also includes an occurring unit configured to cause an event corresponding to an object to occur in accordance with a positional condition regarding a user virtual position in the virtual space corresponding to the positional information of the user terminal and a position of the arranged object.

According to still another non-limiting aspect of the present disclosure, there is provided a non-transitory computer-readable medium including a video game processing program for causing a user terminal to perform functions to control progress of a video game using positional information of the user terminal in response to an operation of a user.

The functions include a first specifying function configured to specify at least one position in a virtual space as a first position in accordance with a first rule, the virtual space corresponding to map information of a real space.

The functions also include a second specifying function configured to specify at least one position in the virtual space as a second position in accordance with a second rule different from the first rule.

The functions also include an arranging function configured to arrange a predetermined object at any or both of the first position and the second position.

The functions also include an occurring function configured to cause an event corresponding to an object to occur in accordance with a positional condition regarding a user virtual position in the virtual space corresponding to the positional information of the user terminal and a position of the arranged object.

According to each of the embodiments of the present application, one or two or more shortages are solved.

### BRIEF DESCRIPTION OF DRAWINGS

The foregoing and other objects, features and advantages of the present disclosure will become more readily apparent from the following detailed description or preferred embodiments of the present disclosure that proceeds with reference to the appending drawings:

FIG. 1 is a block diagram illustrating an example of a configuration of a video game processing system corresponding to at least one of the embodiments of the present disclosure;

FIG. 2 is a block diagram illustrating a configuration of a server corresponding to at least one of the embodiments of the present disclosure;

FIG. 3 is a flowchart illustrating an example or game processing corresponding to at least one of the embodiments of the present disclosure;

FIG. 4 is a flowchart illustrating an example of an operation of a server side in the game processing corresponding to at least one of the embodiments of the present disclosure:

FIG. 5 is a flowchart illustrating an example of an operation of a terminal side in the game processing corresponding to at least one of the embodiments of the present disclosure;

FIG. 6 is a block diagram illustrating a configuration of a server corresponding to at least one of the embodiments of the present disclosure;

FIG. 7 is a flowchart illustrating an example or game processing corresponding to at least one of the embodiments of the present disclosure;

FIG. 8 is a block diagram illustrating a configuration of a server corresponding to at least one of the embodiments of the present disclosure;

FIG. 9 is a flowchart illustrating an example of game processing corresponding to at least one of the embodiments of the present disclosure;

FIG. 10 is a block diagram illustrating a configuration of a server corresponding to at least one or the embodiments of the present disclosure;

FIG. 11 is a flowchart illustrating an example of game processing corresponding to at least one of the embodiments of the present disclosure;

FIG. 12 is a block diagram illustrating a configuration of a server corresponding to at least one of the embodiments of the present disclosure;

FIG. 13 is an explanatory drawing for explaining an example of a storage state of information corresponding to at least one of the embodiments of the present disclosure:

FIG. 14 is a flowchart illustrating an example of game processing corresponding to at least one of the embodiments of the present disclosure; and

FIG. 15 is an explanatory drawing illustrating an example of a display screen corresponding to at least one of the embodiments of the present disclosure.

### DETAILED DESCRIPTION

Hereinafter, examples of embodiments according to the present disclosure will be described with reference to the drawings. Note that various components in the respective embodiments described below can be appropriately combined without any contradiction or the like. In addition, the description of the content described as a certain embodiment may be omitted in another embodiment. Further, the content of an operation or processing that does not relate to features of each of the embodiments may be omitted. Moreover, the order of various processes that constitute various flows described below may be changed without any contradiction or the like of processing content.

### First Embodiment

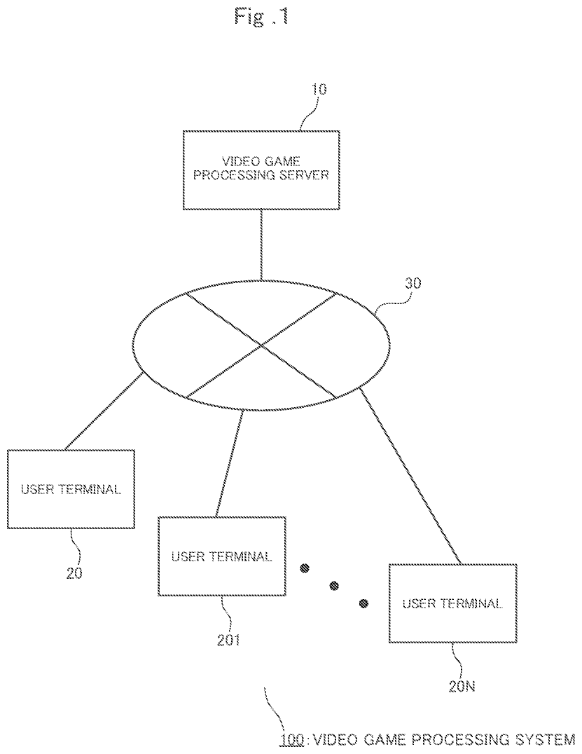

FIG. 1 is a block diagram illustrating an example of a configuration of a video game processing system 100 according to one embodiment of the present disclosure. As illustrated in FIG. 1, the video game processing system 100 includes a video game processing server 10 (hereinafter, referred to as a “server 10”) and user terminals 20, and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not illustrated in the drawings, the plurality of user terminals 20 and 201 to 20N is connected to the communication network 30 by executing data communication with base stations managed by a telecommunication carrier by means of a radio communication line.

The video game processing system 100 includes the server 10 and the plurality of user terminals 20 and 201 to 20N, whereby various kinds of functions for executing various kinds of processing in response to an operation of the user are performed.

The server 10 is managed by an administrator of the video game processing system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. In this regard, the server 10 is provided with a general configuration for executing the various kinds of processing as a computer, such as a control section and a communicating section. However, its explanation herein is omitted. Further, in the video game processing system 100, it is preferable that the server 10 manages various kinds of information from a point or view to reduce a processing load on each of the plurality of user terminals 20 and 201 to 20N. However, a storing section for storing various kinds of information may include a storage region in a state that the server 10C an access the storage region. For example, the server 10 may be configured so as to be provided with a dedicated storage region outside the server 10.

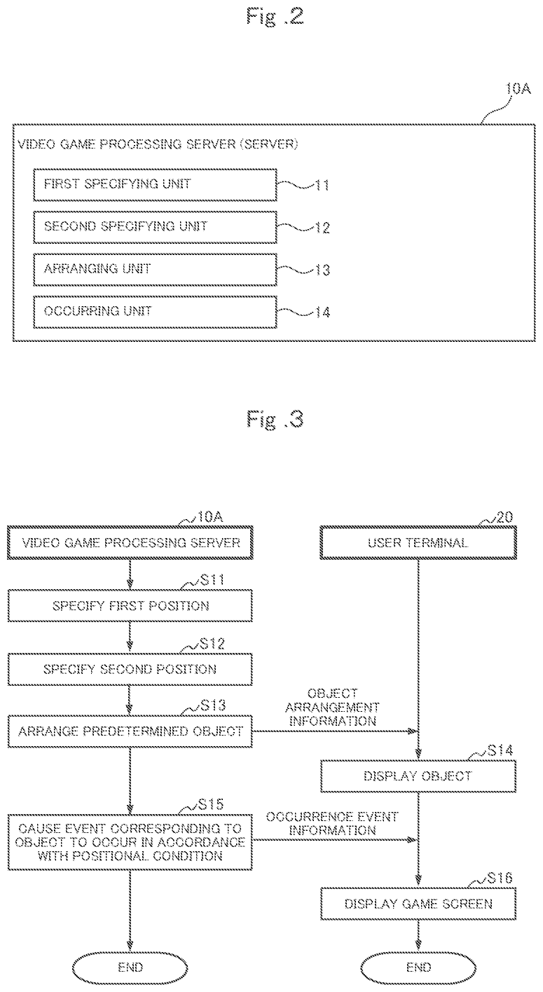

FIG. 2 is a block diagram illustrating a configuration of a video game processing server 10A (hereinafter, referred to as a “server 10A”), which is an example of the server 10. As illustrated in FIG. 2, the server 10A at least includes a first specifying unit 11, a second specifying unit 12, an arranging unit 13, and an occurring unit 14.

The first specifying unit 11 has a function to specify at least one position as a first position in a virtual space corresponding to map information of a real space in accordance with a first rule.

Here, the virtual space corresponding to the map information of the real space means a virtual space that is generated by using the map information of the real space. A configuration to generate the virtual space is not limited particularly. However, it is preferable that the specifying unit 11 is configured so that the user can recognize that the virtual space is generated on the basis of the map information of the real space. As an example of such a configuration, there is a configuration in which the virtual space is generated by respectively arranging objects corresponding to roads and buildings in the real space at positions corresponding to roads and buildings in the real space. In this regard, a configuration to associate the position in the real space with the position in the virtual space is not limited particularly. However, the first specifying unit 11 may be configured so that a coordinate in the real space and a coordinate in the virtual space are defined in a one-to-one relationship, or may be configured so that the coordinates are defined in a plural-to-one relationship or a one-to-plural relationship.

Further, the first rule means a rule for specifying the first position in the virtual space. The first rule is not limited particularly. However, it is preferable that the first rule is a rule for specifying positions substantially evenly in the virtual space, and a rule for specifying positions on the basis of a position in the virtual space corresponding to current positional information of the user terminal 20 (hereinafter, referred to as a “user virtual position”). As examples of the first rule, there are a rule for specifying positions in the virtual space so that the density per predetermined area becomes substantially uniform, and a rule for specifying positions at each of which a distance to the user virtual position is equal to or shorter than a predetermined distance.

Further, a configuration to specify at least one position as the first position is not limited particularly. However, the first specifying unit 11 may be configured so as to specify a plurality of positions as the first position at one time, or may be configured so as to specify the first position sequentially. As an example of such a configuration, there is a configuration in which a predetermined number of positions is specified as the first position on the basis of a user position each time a predetermined time elapses.

The second specifying unit 12 has a function to specify at least one position in the virtual space as a second position in accordance with a second rule different from the first rule.

Here, the second rule means a rule for specifying the second position in the virtual space, and is at least different from the first rule. The second rule is not limited particularly. However, it is preferable that the second rule is a rule in which the second position becomes at least different distribution from that of the first position. As examples of the second rule, there are a rule for specifying positions on the basis of a predetermined reference position in the virtual space, a rule for specifying any position in a region defined in advance in the virtual space, a rule for specifying a position of any coordinate selected from a plurality of coordinates defined in advance in the virtual space, and a rule for specifying positions on the basis of a position or a region in the virtual space corresponding to a predetermined location in the real space. In this regard, a configuration of the region is not limited particularly. However, the second specifying unit 12 may be configured so that the second rule is provided with reference to a predetermined position.

Further, a configuration to specify at least one position as the second position is not limited particularly. However, it may be configured so as not to consider the first position. As an example of such a configuration, there is a configuration in which the second position is specified independently of a process of the first specifying unit 11.

The arranging unit 13 has a function to arrange a predetermined object at any or both of the first position and the second position.

Here, the phrase “any or both of the first position and the second position” means any or both at least one position specified as the first position by the first specifying unit 11 and at least one position specified as the second position by the second specifying unit 12.

Further, the phrase “arrange a predetermined object” means that the predetermined object is associated with a position in the virtual space. Here, a configuration to arrange the predetermined object is not limited particularly. However, it is preferable that in a case where a position at which the predetermined object is arranged or a region corresponding to the object and including the position is included in a display region of the terminal 20, the object is arranged so as to be able to be displayed on a display screen of the terminal 20.

Further, the predetermined object means an object that is defined as an object arranged at any or both of the first position and the second position. The predetermined object is not limited particularly. However, it is preferable to be an object that is selected from a plurality of objects defined as the object arranged at any or both of the first position and the second position.

The occurring unit 14 has a function to cause an event corresponding to the object to occur in accordance with a positional condition regarding a position in the virtual space corresponding to positional information of the user terminal 20 (the user virtual position) and the position of the arranged object.

Here, the positional information of the user terminal 20 means information indicating a position of the user terminal 20 in the real space. A configuration of the positional information is not limited particularly. However, it is preferable that the specifying unit 11 is configured so as to include a coordinate by which the position of the user terminal 20 in the real space can be specified. As examples of the configuration to obtain the positional information of the user terminal 20, there are a configuration to obtain the positional information by using a GPS signal, and a configuration to obtain the positional information on the basis of reception intensity information of wireless signals from a plurality of beacon transmitters.

Further, the phrase “positional condition regarding the user virtual position and the position of the arranged object” means a condition in which the user virtual position and the position of the object arranged by the arranging unit 13 have a predetermined relationship. As an example of the positional condition, there is a condition in which the user virtual position and the position of the object have a predetermined relationship and a selection operation against the object is carried out by the user.

Further, the event corresponding to the object means an event that is associated with the object in advance. The event corresponding to the object is not limited particularly. However, it is preferable that the event is an event related to a type of the object. As an example of the event corresponding to the object, there is an event in which in a case where an object is an enemy character object, a character corresponding to the user (for example, a user character that is one or more character, which can be operated by the user) fights with the enemy character. In this regard, the user character may be configured so that a part or all of the user character is displayed on a game screen, or may be configured so that the user character is not displayed at all.

Each of the plurality of user terminals 20, and 201 to 20N is managed by the user, and is configured by a communication terminal capable of playing a network delivery type game, such as a cellular telephone terminal, a PDA (Personal Digital Assistants), a portable game apparatus, or a so-called wearable device, for example. In this regard, the configuration of the user terminal that the video game processing system 100 can include is not limited to the example described above. Each of the user terminals 20, and 201 to 20N may be configured so that the user can recognize the video game. As the other examples of the user terminal, there are one obtained by combining various kinds of communication terminals, a personal computer, and a stationary game apparatus.

Further, each of the plurality of user terminals 20, and 201 to 20N is connected to the communication network 30, and includes hardware (for example, a display device for displaying a browser screen or a game screen based on a coordinate and the like) and software for executing various kinds of processes by communicating with the server 10A. In this regard, each of the plurality of user terminals 20, and 201 to 20N may be configured so as to be able to directly communicate with each other without the server 10A.

Next, an operation of the video game processing system 100 (hereinafter, referred to as a “system 100”) according to the present embodiment will be described.

FIG. 3 is a flowchart illustrating an example of game processing executed by the system 100. In the game processing according to the present embodiment, processes related to a control of progress of the video game using the positional information of the user terminal 20 in response to an operation of the user are executed. Hereinafter, a case where the server 10A and the user terminal 20 (hereinafter, referred to as the “terminal 20”) execute the game processing will be described as an example.

The game processing is started as an opportunity that the terminal 20 accessing the server 10A requests display of the virtual space, for example.

In the game processing, the server 10A first specifies at least one position in a virtual space as a first position in accordance with a first rule (Step S11). Further, the server 10A specifies at least one position in the virtual space as a second position in accordance with a second rule (Step S12).

When the first position and the second position are specified, the server 10A arranges a predetermined object at any or both of the first position and the second position (Step S13). In the present embodiment, when the predetermined object is arranged, the server 10A transmits, to the terminal 20, object arrangement information for arranging the object.

When the object arrangement information is received, the terminal 20 arranges the predetermined object on the basis of the object arrangement information received from the server 10A. In a case where a position at which the object is arranged or a region corresponding to the object and including the position is included in a display region of the terminal 20, the terminal 20 outputs a game screen including an object image to a display screen of a predetermined display device (Step S14).

When the predetermined object is arranged, the server 10A causes an event corresponding to the object to occur in accordance with a positional condition regarding a user virtual position and a position of the arranged object (Step S15). In the present embodiment, when the predetermined object is arranged, the server 10A transmits occurrence event information for causing the event corresponding to the object to occur to the terminal 20. When the occurrence event information is received, the terminal 20 displays a game screen in accordance with the received occurrence event information (Step S16). When the event corresponding to the object is caused to occur, the server 10A and the terminal 20 terminate the processes herein.

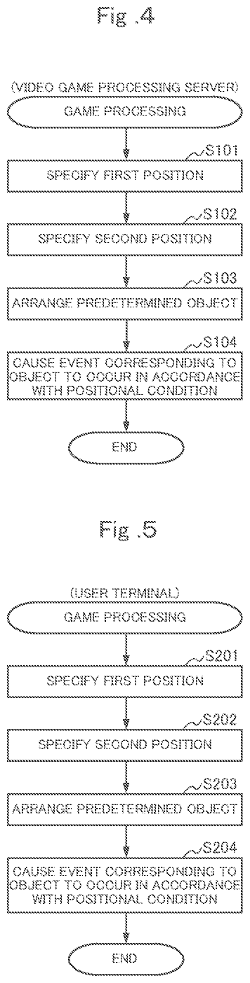

FIG. 4 is a flowchart illustrating an example of an operation of the server 10A side in the game processing. Here, an operation of the server 10A in the system 100 will be described again.

In the game processing, the server 10A first specifies at least one position in a virtual space as a first position in accordance with a first rule (Step S101); specifies at least one position in the virtual space as a second position in accordance with a second rule (Step S102); arranges a predetermined object at any or both of the first position and the second position (Step S103); and causes an event corresponding to the object to occur in accordance with a positional condition regarding a user virtual position and a position of the arranged object (Step S104). When the event corresponding to the object is caused to occur, the server 10A terminates the processes herein.

FIG. 5 is a flowchart illustrating an example of an operation of the terminal 20 side in a case where the terminal 20 executes the game processing. Hereinafter, a case where the terminal 20 executes the game processing by a single body will be described as an example. In this regard, the configuration of the terminal 20 includes the similar functions to those of the server 10A except that the terminal 20 receives various kinds of information from the server 10. For this reason, its explanation is omitted from a point of view to avoid repeated explanation.

In the game processing, the terminal 20 first specifies at least one position in a virtual space as a first position in accordance with a first rule (Step S201); specifies at least one position in the virtual space as a second position in accordance with a second rule (Step S202); arranges a predetermined object at any or both of the first position and the second position (Step S203); and causes an event corresponding to the object to occur in accordance with a positional condition regarding a user virtual position and a position of the arranged object (Step S204). When the event corresponding to the object is caused to occur, the terminal 20 terminates the processes herein.

As explained above, as one side of the first embodiment, the server 10A for performing the functions to control progress of the video game using the positional information of the user terminal in response to the operation of the user is configured so as to include the first specifying unit 11, the second specifying unit 12, the arranging unit 13, and the occurring unit 14. Thus, the first specifying unit 11 specifies at least one position in the virtual space corresponding to the map information of the real space as the first position in accordance with the first rule; the second specifying unit 12 specifies at least one position in the virtual space as the second position in accordance with the second rule different from the first rule; the arranging unit 13 arranges the predetermined object at any or both of the first position and the second position; and the occurring unit 14 causes the event corresponding to the object to occur in accordance with the positional condition regarding the position in the virtual space corresponding to positional information of the user terminal 20 (the user virtual position) and the position of the arranged object. Therefore, it becomes possible to maintain interest of the user in the video game.

Namely, compared with a case where an object is arranged in a virtual space in accordance with a single rule, by arranging the object at the position specified in accordance with the first rule or the second rule, it is possible to improve diversity of the position of the object. As a result, it is possible to give diversity to progress of the event corresponding to the object, and it is possible to prevent the user from losing interest in progress of the video game. In other words, in the present embodiment, the object is arranged using two types of rules so that the positions of the objects do not become monotonous. Therefore, in a case where the user moves in the real space to cause the event corresponding to the object to occur, it is possible to cause the user to consider the order and the type of objects that the events are caused to occur compared with a case where an object is arranged using a single rule, for example.

### Second Embodiment

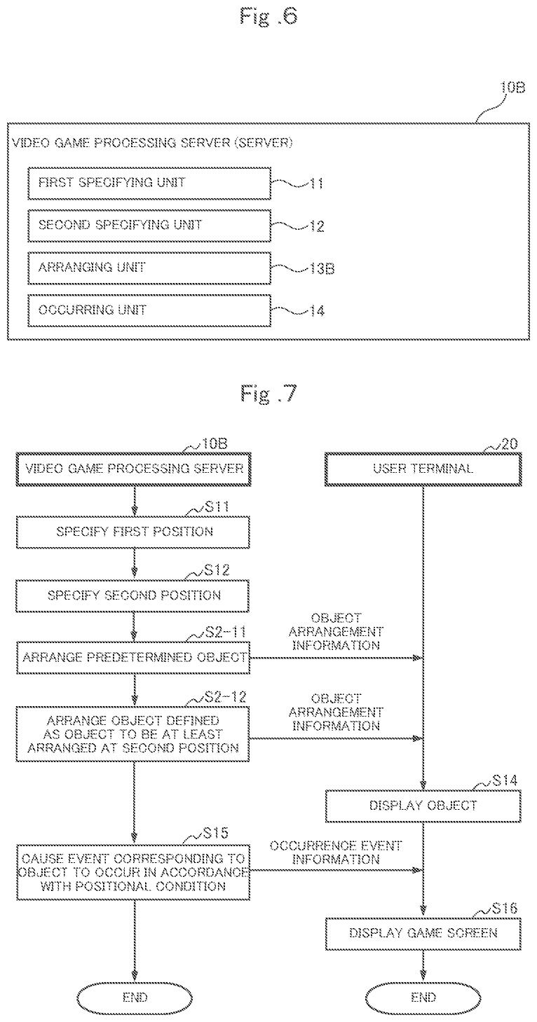

FIG. 6 is a block diagram illustrating a configuration of a video game processing server 10B (hereinafter, referred to as a “server 10B”), which is an example of the video game processing server 10. In the present embodiment, the server 10B at least includes a first specifying unit 11, a second specifying unit 12, an arranging unit 13B, and an occurring unit 14.

The arranging unit 13B has a function to arrange an object, which is defined as an object to be at least arranged at a second position, at a second position as a predetermined object.

Here, the phrase “object defined as an object to be at least arranged at a second position” means an object that can be arranged at the second position regardless of whether the object can be arranged at a first position or not. A configuration to define an object is not limited particularly. However, it is preferable that the arranging unit 13B is configured so that an object having a predetermined attribute is arranged at the second position. As an example of such a configuration, there is a configuration in which one object or a plurality of objects to which an attribute in a video game is set and the second position are registered so as to be associated with each other. In this regard, as examples of the object defined as the object to be at least arranged at the second position, there are an object in which a corresponding event includes predetermined content and an object in which a probability of being arranged at the first position is relatively low.

FIG. 7 is a flowchart illustrating an example of game processing executed by the video game processing system 100 (see FIG. 1). Hereinafter, operations of the server 10B and a user terminal 20 (hereinafter, referred to as a “terminal 20”) will be described as an example. In this regard, a flowchart illustrating an operation of each of the server 10B and the terminal 20 is omitted from a point of view to avoid repeated explanation.

In the game processing, when a first position is specified, the server 10B arranges a predetermined object at the first position (Step S2-11). In the present embodiment, when a predetermined object is arranged, the server 10B transmits object arrangement information for arranging the predetermined object to the terminal 20.

When a second position is specified, the server 10B arranges an object, which is defined as an object to be at least arranged at the second position, at the second position (Step S2-12). In the present embodiment, when the object that is defined as the object to be arranged at the second position is arranged, the server 10B transmits the object arrangement information for arranging the object to the terminal 20.

As explained above, as one side of the second embodiment, the server 10B is configured so as to include the first specifying unit 11, the second specifying unit 12, the arranging unit 13B, and the occurring unit 14. Thus, the arranging unit 13B arranges the object, which is defined as the object to be at least arranged at the second position, at the second position as the predetermined object. Therefore, it is possible to cause the object arranged at the second position to have a feature. As a result, it becomes possible to maintain interest of the user in the video game.

### Third Embodiment

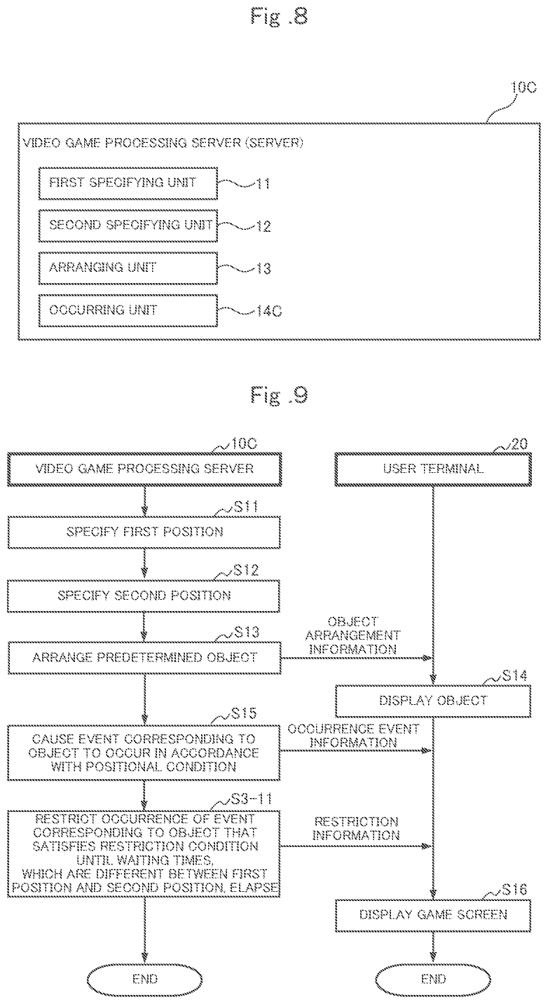

FIG. 8 is a block diagram illustrating a configuration of a video game processing server 10C (hereinafter, referred to as a “server 10C”), which is an example of the video game processing server 10. In the present embodiment, the server 10C at least includes a first specifying unit 11, a second specifying unit 12, an arranging unit 13, and an occurring unit 14C.

The arranging unit 13 has a function to arrange a plurality of objects at any or both of a first position and a second position. The occurring unit 14C has a function to restrict, in a case where an event corresponding to an object occurs, occurrence of an event corresponding to a predetermined object satisfying a restriction condition of the plurality of objects arranged by the arranging unit 13 until a waiting time elapses after occurrence of the event. In this case, the waiting time in a case where the predetermined object is at least arranged at the first position is different from the waiting time in a case where the predetermined object is arranged at the second position.

Here, the phrase “after occurrence of the event” means after a point of time when the event occurs. The “after occurrence of the event” is not limited particularly. However, it is preferable that it is after a point of time when a user can recognize that restriction of occurrence of the event is started. As examples of “after occurrence of the event”, there are after a point of time when the event starts, after a point of time when the event ends, and after a predetermined point of time in the started event.

Further, the waiting time is a period of time when occurrence of the event corresponding to the object is to be restricted, and means a time that is at least different between a case where the object for which the event occurs is arranged at the first position and a case where the object for which the event occurs is arranged at the second position. The waiting time is not limited particularly. However, it is preferable that a waiting time in a case where an object corresponding to an event that occurs is arranged at the second position is shorter compared with a waiting time in a case where the object is arranged at the first position. As examples of the waiting time, there are a time corresponding to each object, and a time corresponding to each of a case where an object is arranged at the first position and a case where an object is arranged at the second position.

Further, the restriction condition means a condition of an object for which occurrence of a corresponding event is restricted. The restriction condition is not limited particularly. However, it is preferable that the restriction condition is a condition related to an object for which an event occurs. As examples of the restriction condition, there are a condition that an object is an object itself for which an event occurs, and a condition that an object is an object having a predetermined relationship with an object for which an event occurs.

Further, the phrase “restrict occurrence of an event corresponding to a predetermined object” means controlling so that an event corresponding to an object satisfying a restriction condition is not caused to occur regardless of a positional condition regarding a user virtual position and a position of the object. A configuration to restrict occurrence of an event corresponding to an object is not limited particularly. However, it is preferable that the occurring unit 14C is configured so that the user can recognize that occurrence of the event is restricted. As examples of the configuration to restrict occurrence of an event corresponding to an object, there are a configuration in which an event corresponding to an object satisfying a restriction condition is not caused to occur even in a case where the object is displayed on a game screen, and a configuration in which an object satisfying a restriction condition is not displayed and an event corresponding to the object is not caused to occur. In this regard, as examples of the configuration not to display an object, there are a configuration in which an object is not displayed while arranging the object, and a configuration in which an object is deleted from the virtual space (that is, it is set to a state where the object is not arranged in the virtual space).

FIG. 9 is a flowchart illustrating an example of game processing executed by the video game processing system 100 (see FIG. 1). Hereinafter, operations of the server 10C and a user terminal 20 (hereinafter, referred to as a “terminal 20”) will be described as an example. In this regard, a flowchart illustrating an operation of each of the server 10C and the terminal 20 is omitted from a point of view to avoid repeated explanation.

In the game processing, when an event corresponding to an object is caused to occur, the server 10C restricts occurrence of the event corresponding to the object satisfying a restriction condition until a waiting time, which is different from each other between a case where the object is arranged at a first position and a case where the object is arranged at a second position, elapses after occurrence of the event (Step S3-11). In the present embodiment, when the event corresponding to the object occurs, the server 10C transmits restriction information for restricting occurrence of the event corresponding to the object satisfying the restriction condition to the terminal 20.

As explained above, as one side of the third embodiment, the server 10C is configured so as to include the first specifying unit 11, the second specifying unit 12, the arranging unit 13, and the occurring unit 14C. Thus, the arranging unit 13 arranges the plurality of objects at any or both of the first position and the second position; the occurring unit 14C restricts, in a case where the event corresponding to the object occurs, occurrence of the event corresponding to the predetermined object satisfying the restriction condition of the plurality of arranged objects until the waiting time, which is different from each other between a case where the predetermined object is at least arranged at the first position and a case where the predetermined object is arranged at the second position, elapses after occurrence of the event. Therefore, compared with a case where a waiting time is the same as each other between a case where an object is arranged at the first position and a case where the object is arranged at the second position, it is possible to cause timing to occur an event and a way to cause a video game to proceed by the user to have variation. As a result, it becomes possible to maintain interest of the user in the video game.

### Fourth Embodiment

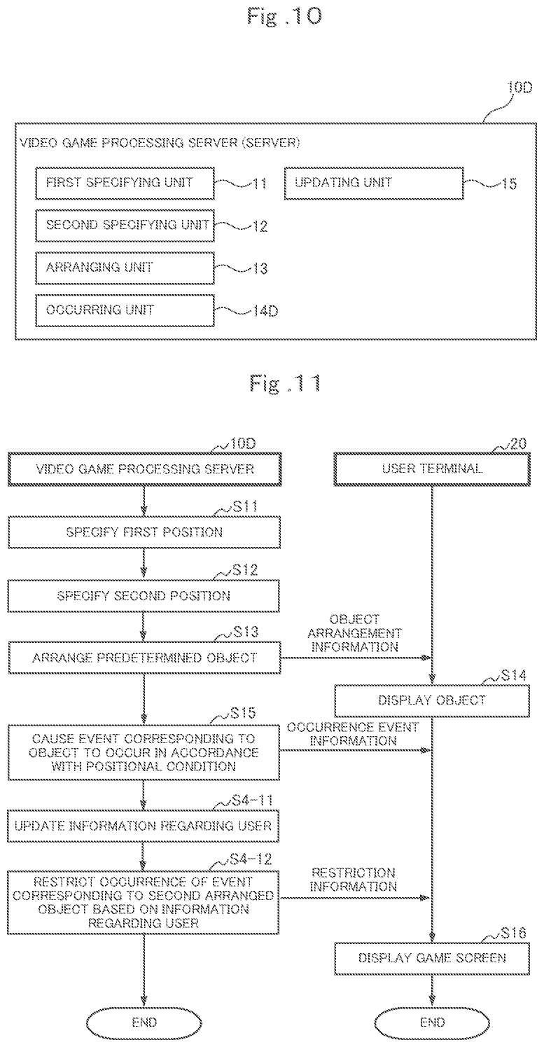

FIG. 10 is a block diagram illustrating a configuration of a video game processing server 10D (hereinafter, referred to as a “server 10D”), which is an example of the video game processing server 10 (see FIG. 1). In the present embodiment, the server 10D at least includes a first specifying unit 11, a second specifying unit 12, an arranging unit 13, an occurring unit 14D, and an updating unit 15.

The updating unit 15 has a function to update information regarding a user on the basis of an occurrence situation of an event corresponding to an object arranged at a second position (hereinafter, referred to as a “second arranged object”).

Here, the phrase “update information regarding a user on the basis of an occurrence situation of an event” means that the information regarding the user is updated using information defined on the basis of an occurrence situation of an event corresponding to an object.

Further, the occurrence situation of the event means a situation regarding the event that occurs. The occurrence situation of the event is not limited particularly. However, it is preferable that the occurrence situation of the event is an initial situation or a progress situation of the event that occurs. As examples of the occurrence situation of the event, there are an initial situation defined on the basis of information related to the event, and a situation when the event ends as an end result.

Further, the information regarding the user is not limited particularly. However, it is preferable that the information regarding the user is information individually associated with each user. As an example of the information regarding the user, there is a parameter that increases or decreases in accordance with progress of a video game. As such an example, there is a numeral number that varies depending upon an occurrence situation of an event (for example, an occurrence number or a cleared number) or usage of an item.

The occurring unit 14D has a function to restrict occurrence of the event corresponding to the second arranged object on the basis of the information regarding the user.

Here, the phrase “restrict occurrence of the event corresponding to the second arranged object on the basis of the information regarding the user” means that it is determined whether to restrict occurrence of the event corresponding to the second arranged object or not on the basis of the information regarding the user, and occurrence of the event is restricted in a case where it is determined to restrict occurrence of the event. A configuration to restrict occurrence of the event corresponding to the second arranged object on the basis of the information regarding the user is not limited particularly. However, it is preferable that the occurring unit 14D is configured to restrict occurrence of the event so that it is impossible or difficult compared with before the restriction to cause the event corresponding to the second arranged object to occur. As examples of the configuration to restrict occurrence of the event corresponding to the second arranged object on the basis of the information regarding the user, there are a configuration in which occurrence of the event is restricted until it is determined that occurrence of the event corresponding to the second arranged object is not restricted on the basis of the information regarding the user, a configuration in which occurrence of the event corresponding to the second arranged object is restricted until a predetermined time elapses on the basis of the information regarding the user, and a configuration in which occurrence of the event corresponding to the second arranged object is restricted within a predetermined zone in the virtual space.

FIG. 11 is a flowchart illustrating an example of game processing executed by the system 100. Hereinafter, operations of the server 10D and the user terminal 20 (hereinafter, referred to as the “terminal 20”) will be described as an example. In this regard, a flowchart illustrating an operation of each of the server 10D and the terminal 20 is omitted from a point of view to avoid repeated explanation.

In the game processing, when an event corresponding to a second arranged object is caused to occur, the server 10D updates information regarding a user on the basis of an occurrence situation of the event corresponding to the second arranged object (Step S4-11).

When the information regarding the user is updated, the server 10D restricts occurrence of an event corresponding to a second arranged object on the basis of information regarding the user (Step S4-12). In the present embodiment, when the information regarding the user is updated, the server 10D transmits restriction information for restricting the occurrence of the event corresponding to the second arranged object to the terminal 20.

As explained above, as one side of the fourth embodiment, the server 10D is configured so as to include the first specifying unit 11, the second specifying unit 12, the arranging unit 13, the occurring unit 14D, and the updating unit 15. Thus, the updating unit 15 updates, when the event corresponding to the second arranged object is caused to occur, the information regarding the user on the basis of the occurrence situation of the event corresponding to the second arranged object; and the occurring unit 14D restricts occurrence of the event corresponding to the second arranged object on the basis of the information regarding the user. Therefore, when the event corresponding to the second arranged object is caused to occur, compared with a case where occurrence of the event is not restricted, it is possible to improve diversity of progress of the event by the user by causing the user to consider the occurrence situation of the event. As a result, it becomes possible to maintain interest of the user in the video game.

### Fifth Embodiment

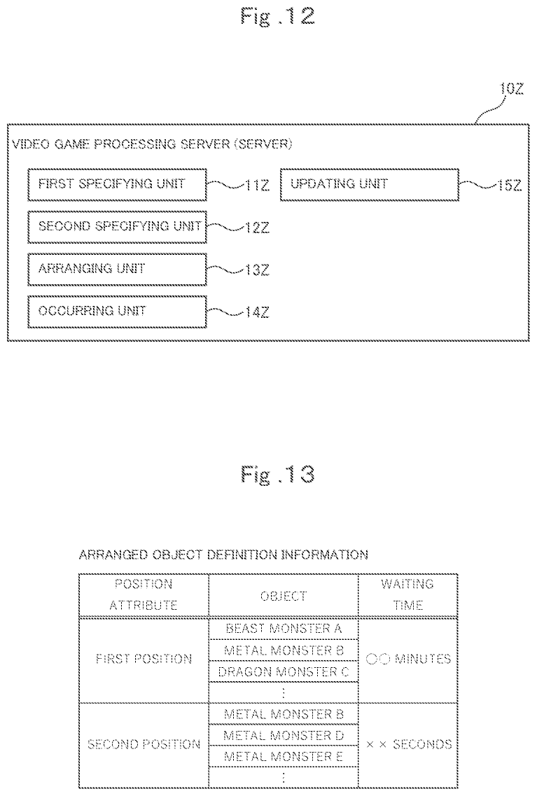

FIG. 12 is a block diagram illustrating a configuration of a video game processing server 10Z (hereinafter, referred to as a “server 10Z”), which is an example of the video game processing server 10 in the video game processing system 100 (see FIG. 1). In the present embodiment, the server 10Z at least includes a first specifying unit 11Z, a second specifying unit 12Z, an arranging unit 13Z, an occurring unit 14Z, and an updating unit 15Z.

The first specifying unit 11Z has a function to specify at least one position as a first position in a virtual space corresponding to map information or a real space in accordance with a first rule.

Here, the virtual space corresponding to the map information of the real space means a virtual space that is generated by using the map information of the real space. Hereinalter, a configuration to generate a virtual space by respectively arranging objects corresponding to roads and buildings in the real space at positions corresponding to the real space will be described as an example.

Further, the first rule means a rule for specifying the first position in the virtual space. Hereinafter, a configuration in which the first rule is a rule of specifying any position around a user character in the virtual space (for example, a position within a predetermined distance from a position in the virtual space corresponding to positional information of a user terminal 20) as the first position will be described as an example. In this regard, the first specifying unit 11Z may be configured so that the first rule is a rule of specifying a random position in the virtual space as the first position.

Further, a configuration to specify at least one position as the first position is not limited particularly. However, the first specifying unit 11Z may be configured so as to specify a plurality of positions as the first position at one time, or may be configured so as to specify the first position sequentially. As an example of such a configuration, there is a configuration in which a predetermined number of positions is specified as the first position on the basis of a position in the virtual space corresponding to the positional information of the user terminal 20 each time a predetermined time elapses.

The second specifying unit 12Z has a function to specify at least one position in the virtual space as a second position in accordance with a second rule different from the first rule.

Here, the second rule means a rule for specifying the second position in the virtual space, and is at least different from the first rule. Hereinafter, a configuration in which the second rule is a rule of randomly selecting a mesh in the virtual space and specifying any position within a predetermined distance as the second position by using the selected mesh as a reference will be described as an example. In the present embodiment, the second rule is a rule of specifying a position in a region (hereinafter, referred to as a “group region of monsters”), in which an object (for example, a monster) whose appearance probability is normally low is set to have a high appearance probability and spring out easily, as the second position. In this regard, in the present embodiment, objects displayed in the group region of the monsters may be referred to as group character objects.

Further, a configuration to specify at least one position as the second position is not limited particularly. However, it may be configured so as not to consider the first position. In the present embodiment, the second specifying unit 12Z is configured to specify the second position independently of the process of the first specifying unit 11Z.

The arranging unit 13Z has a function to arrange a predetermined object at any or both of the first position and the second position.

Here, the phrase “any or both of the first position and the second position” means any or both at least one position specified as the first position by the first specifying unit 11Z and at least one position specified as the second position by the second specifying unit 12Z.

Further, the phrase “arrange a predetermined object” means that the predetermined object is associated with a position in the virtual space. Hereinafter, a case where the predetermined object is an enemy character object will be described as an example. In this regard, in the present embodiment, the user terminal 20 obtains information from the server 10Z on the basis of its own positional information, and displays a game screen including an object in a case where the object is arranged in the virtual space corresponding to a display range.

Further, the arranging unit 13Z has a function to arrange an object defined as an object to be at least arranged at the second position as the predetermined object.

Here, the object defined as the object to be at least arranged at the second position means an object defined as an object to be arranged at the second position regardless of whether the object is defined as an object to be arranged at the first position or not. Hereinafter, a configuration in which the enemy character object with appearance of an enemy character that has a predetermined attribute (for example, metallic) is defined as the object to be arranged at the second position will be described as an example.

The occurring unit 14Z has a function to cause an event corresponding to the object to occur in accordance with a positional condition regarding a position in the virtual space corresponding to positional information of the user terminal 20 (hereinafter, referred to as a “user virtual position”) and the position of the arranged object.

Here, the positional information of a user terminal 20 means information indicating a location in a real space. Hereinafter, a configuration in which positional information using a GPS signal is the positional information of the user terminal 20 will be described as an example.

Further, the phrase “positional condition regarding the user virtual position and the position of the arranged object” means a condition in which the user virtual position and the position of the object arranged by the arranging unit 13Z have a predetermined relationship. Hereinafter, a configuration in which the positional condition is a condition that a distance between the user virtual position and position of the object arranged by the arranging unit 13Z is equal to or shorter than a predetermined distance and it is satisfied in a case where the user carries out a selection operation against the object will be described as an example.

Further, the event corresponding to the object means an event that is associated with the object in advance. Hereinafter, a configuration in which an event corresponding to the enemy character object and the group character objects is a battle event against the enemy character by the user character will be described as an example.

Further, the arranging unit 13 has a function to arrange a plurality of objects at any or both of a first position and a second position. The occurring unit 14Z has a function to restrict, in a case where an event corresponding to an object occurs, occurrence of an event corresponding to a predetermined object satisfying a restriction condition of the plurality of objects arranged by the arranging unit 13Z until a waiting time elapses after occurrence of the event. In this case, the waiting time in a case where the predetermined object is at least arranged at the first position is different from the waiting time in a case where the predetermined object is arranged at the second position.

Here, the phrase “after occurrence of the event” means after a point of time when the event occurs. Hereinafter, a configuration in which a time after occurrence of the event is after a point of time when the event starts, after a point of time when the event ends, or after a predetermined point of time in the started event will be described as an example.

Further, the waiting time is a period of time when occurrence of the event corresponding to the object is to be restricted, and means a time that is at least different between a case where the object for which the event occurs is arranged at the first position and a case where the object for which the event occurs is arranged at the second position. Hereinafter, a configuration in which the waiting time is a period of time from a time when the enemy character for which the battle event occurs disappears to a time when another enemy character reappears (or is rearranged) will be described as an example. Further, hereinafter, a configuration in which a waiting time in a case where the enemy character object for which the battle event occurs is arranged at the second position is shorter compared with a waiting time in a case where the enemy character object for which the battle event occurs is arranged at the first position will be described as an example.

Further, the restriction condition means a condition of an object for which occurrence of a corresponding event is restricted. Hereinafter, a configuration in which in a case where an object of which an event occurs is an object arranged at the first position, the restriction condition is a condition to be the object itself will be described as an example. Hereinafter, a configuration in which in a case where an object for which an event occurs is an object arranged at the second position (hereinafter, referred to as a “second arranged object”), the restriction condition is a condition that the object is a second arranged object within a predetermined region in which the object is positioned will be described as an example.

Further, the phrase “restrict occurrence of an event corresponding to an object” means controlling so that an event corresponding to an object satisfying a restriction condition is not caused to occur regardless of a positional condition regarding a user virtual position and a position of the object. Hereinafter, a configuration in which by deleting an enemy character object satisfying a restriction condition from the virtual space or not displaying it, a battle event corresponding to the deleted or not-displayed enemy character object is not caused to occur will be described as an example.

The updating unit 15Z has a function to update information regarding the user on the basis of an occurrence situation of the event corresponding to the second arranged object.

Here, a configuration to update information regarding the user on the basis of an occurrence situation of the event is not limited particularly. However, this configuration means that the information regarding the user is updated using information defined on the basis of an occurrence situation of an event. Hereinafter, as the event corresponding to the second arranged object, a battle event against an enemy character including a metallic monster will be described as an example. Further, a configuration in which in a case where the user character defeats the metallic monster in the battle event against the metallic monster, a parameter indicating the number of remaining metallic monsters that can be defeated (hereinafter, referred to as a “defeatable parameter”, for example, energy of a metal radar) is updated will be described as an example. In this regard, in the present embodiment, in a case where the defeatable parameter becomes zero or less, a group of monsters (that is, the group character objects) is not displayed, whereby the user is not allowed to cause a battle event corresponding to the non-displayed group character object to occur. In this regard, the updating unit 15Z may be configured so that arrangement of an object at the second position is terminated in a case where the defeatable parameter becomes zero or less. Namely, the updating unit 15Z may be configured so that all the groups are terminated in a case where the number of metallic monsters that can be defeated by the user becomes zero.

Further, the occurrence situation of the event means a situation regarding the event that occurs. In the present embodiment, the occurrence situation of the event is a defeat situation of the metallic monster in the battle event against the enemy character.

Further, the information regarding the user is not limited particularly. However, it is preferable that the information regarding the user is information individually associated with each user. In the present embodiment, the information regarding the user is the defeatable parameter individually associated with each user.

Further, the occurring unit 14Z has a function to restrict occurrence of the event corresponding to the second arranged object on the basis of the information regarding the user.

Here, the phrase “restrict occurrence of the event corresponding to the second arranged object on the basis of the information regarding the user” means that it is determined whether occurrence of the event is restricted or not on the basis of the information regarding the user, and occurrence of the event corresponding to the second arranged object is restricted in a case where it is determined that occurrence of the event is to be restricted. In this regard, as described above, the occurring unit 14Z controls a display device so as not to display the group of monsters in a case where the user character defeats the metallic monster in the battle event against the enemy character and the defeatable parameter thereby becomes zero; and not to cause a battle event corresponding to a non-displayed group character object to occur.

FIG. 13 is an explanatory drawing for explaining an example of a storage state of information stored in a storage unit (not illustrated in the drawings) that is included in the server 10Z. As illustrated in FIG. 13, the storage unit is configured to store a position attribute, an object, and a waiting time so as to be associated with each other.

Here, the position attribute means an attribute of a position. In the present embodiment, as examples of the position attribute, there are the first position and the second position.

Further, the object means a target to be arranged in the virtual space. In the present embodiment, as types of the object, there are a type to be arranged at the first position and a type to be arranged at the second position. The types of the object are not limited to these. However, it is preferable that a position at which the object is to be arranged is defined. Further, the server 10Z may be configured so that the predetermined attribute is set to the object. By causing the server 10Z to have such a configuration, it further becomes possible to cause each position attribute to have a feature. In the present embodiment, a case where a metallic attribute is set to the object associated with the second position will be described as an example. In this regard, the object defined as the object to be arranged at the second position may be the object defined as the object to be arranged at the first position at the same time. In the present embodiment, a “metal monster B” that is an enemy object is an object defined as an object to be arranged at both the first position and the second position.

Further, the waiting time means a time or a period of time during which occurrence of an event is restricted in a case where the restriction condition is satisfied. In the present embodiment, the waiting time associated with the second position is shorter than the waiting time associated with the first position.

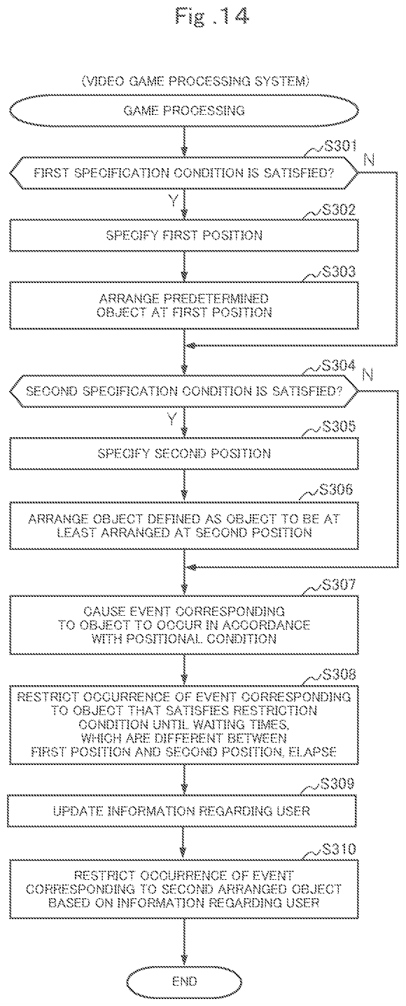

FIG. 14 is a flowchart illustrating an example of game processing executed by a video game processing system 100Z (hereinafter, referred to as a “system 100Z”) provided with the server 10Z. In the game processing according to the present embodiment, processes related to a control of progress of the video game using the positional information of the user terminal 20 in response to an operation of the user are executed. Hereinafter, each of the processes will be described. In this regard, the order of the processes may be changed without any contradiction or the like of processing content.

The game processing is started as an opportunity that the terminal 20 accessing the server 10Z requests display of the virtual space, for example.

In the game processing, first, in a case where a first specification condition is satisfied (“Yes” at Step S301), the system 100Z specifies at least one position in a virtual space as a first position in accordance with a first rule (Step S302). In the present embodiment, the first specification condition is a condition that a display request of the virtual space is received from the user. In a case where the display request of the virtual space is received from the user, the system 100Z specifies at least one position around a user virtual position in the virtual space as the first position.

When the first position is specified, the system 100Z arranges a predetermined object at the first position (Step S303). In the present embodiment, when the first position is specified, the system 100Z arranges an enemy character object at the first position.

On the other hand, in a case where the first specification condition is not satisfied (“No” at Step S301), the system 100Z causes the processing flow to proceed to Step S304.

In a case where a second specification condition is satisfied (“Yes” at Step S304), the system 100Z specifies at least one position in the virtual space as a second position in accordance with a second rule (Step S305). In the present embodiment, a case where the second specification condition is a condition that it is during a period of a specific event in which a large number of metallic monsters appear will be described as an example. Further, in the present embodiment, in a case where the current time is during the specific event, the system 100Z specifies at least one position in a region of a group of monsters in the virtual space as the second position. In this regard, when the specific event according to the present embodiment is terminated due to a lapse of the period, the group of monsters are also erased from the virtual space.

When the second position is specified, the system 100Z arranges, at the second position, an object that is defined as an object to be at least arranged at the second position (Step S306). In the present embodiment, when the second position is specified, the system 100Z arranges a group character object at the second position.

On the other hand, in a case where the second specification condition is not satisfied (“No” at Step S304), the system 100Z causes the processing flow to proceed to Step S307.

The system 100Z causes an event corresponding to the object to occur in accordance with a positional condition regarding the user virtual position and positions of the arranged objects (Step S307). In the present embodiment, in a case where a distance between the user virtual position and any of the positions of the objects arranged by the arranging unit 13Z is equal to or shorter than a predetermined distance and a selection operation against the object is carried out by the user, the system 100Z causes a battle event corresponding to the object to occur.

When the event corresponding to the object is caused to occur, the system 100Z restricts occurrence of the event corresponding to the object satisfying a restriction condition until a waiting time, which is different from each other between a case where the object is arranged at the first position and a case where the object is arranged at the second position, elapses after occurrence of the event (Step S308). In the present embodiment, when the battle event corresponding to the enemy character object arranged at the first position is caused to occur, the system 100Z controls a display device not to display the enemy character object until the waiting time elapses so that the battle event corresponding to the enemy character object is not caused to occur. Further, when the battle event corresponding to the group character object arranged at the second position is caused to occur, the system 100Z controls the display device not to display the group character object until a waiting time, which is shorter than the waiting time in a case where the enemy character object for which the battle event occurs is arranged at the first position, elapses so that the battle event corresponding to the group character object is not caused to occur.

When the event corresponding to the second arranged object is caused to occur, the system 100Z updates information regarding the user on the basis of an occurrence situation of the event corresponding to the second arranged object (Step S309). In the present embodiment, when the battle event corresponding to the group character object is caused to occur, the system 100Z updates a defeatable parameter so as to subtract the number of metallic monsters defeated in the battle event from the defeatable parameter.

When the information regarding the user is updated, the system 100Z restricts occurrence of the event corresponding to the second arranged object on the basis of the information regarding the user (Step S310). In the present embodiment, in a case where the defealable parameter is updated and the defeatable parameter thus becomes zero or lower, the system 100Z controls the display device not to display the group character object so that the battle event corresponding to the group character object is not caused to occur. When the occurrence of the event corresponding to the object is restricted, the system 100Z terminates the processes herein.

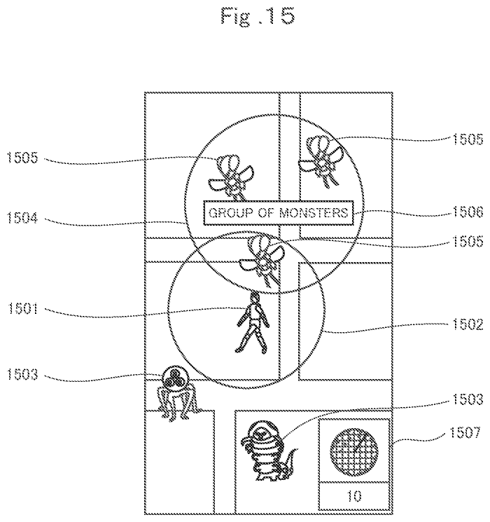

FIG. 15 is an explanatory drawing for explaining an example of the game screen. As illustrated in FIG. 15, a user character 1501 of a user, an event occurrence possible region 1502 based on a position of the user character 1501, an enemy character object 1503, a group region 1504, group character objects 1505, group information 1506, and defeatable parameter information 1507 are illustrated on the game screen.

The user character 1501 is illustrated at a location near the center of the display screen, and is displayed at a position in the virtual space corresponding to positional information of the terminal 20. When the location of the terminal 20 changes in the real space, the user character 1501 moves in the virtual space in the similar manner. Further, the event occurrence possible region 1502 also moves in accordance with movement of the user character 1501.

The event occurrence possible region 1502 is a region in which a condition that a user virtual position and a position of the object have a predetermined relationship is satisfied. This condition is included in the positional condition for causing the event corresponding to the object to occur. When the user carries out a selection operation against the elapse enemy character object 1503 or the group character object 1505 in the event occurrence possible region 1502, a screen for starting a battle against an enemy character is displayed.

The group region 1504 is a region in which a group of monsters is formed in the virtual space. In the present embodiment, the group character objects 1505 are arranged in the group region 1504. A position at which each of the group character objects 1505 is arranged is the second position. Further, an object with appearance of the metallic monster for which a battle event against the metallic monster occurs is arranged as the group character object 1505. Moreover, in the present embodiment, a name unique to the group of monsters is displayed as the group information 1506 so as to be associated with the group region 1504. In this regard, a configuration of the group information is not limited to the name unique to the group of monsters, and may be configured so that the user can identify the group of monsters. As another example of the group information, there is an object associated with the group of monsters (that is, a group object). In this regard, the server 10Z may be configured so that an image for informing the user of the group region of the monsters is displayed on the game screen as the group information or so as to be associated with the group information.

The defeatable parameter information 1507 is a parameter (the defeatable parameter, for example, the energy of the metal radar) that indicates the number of defeatable metallic monsters in the battle event. In a case where the user character defeats the metallic monster in the battle event, the number of defeated metallic monsters is subtracted from the defeatable parameter. Here, in a case where the defeatable parameter becomes zero or less, the group character object 1505 disappears from the virtual space and does not appear newly. As a result, the user is not allowed to cause the battle event corresponding to the group character object 1505 to occur. In this regard, the group character object 1505 is not displayed, and the group region 1504 and group information 1506 are not also displayed. Further, in a case where a predetermined time elapses after the group character object 1505 is not displayed, the group character object 1505 appears again.

As explained above, as one side of the fifth embodiment, the server 10Z for performing the functions to control progress of the video game using the positional information of the user terminal in response to the operation of the user is configured so as to include the first specifying unit 11Z, the second specifying unit 12Z, the arranging unit 13Z, the occurring unit 14Z, and the updating unit 15Z. Thus, the first specifying unit 11Z specifies at least one position as the first position (for example, the random position) in the virtual space corresponding to the map information of the real space in accordance with the first rule; the second specifying unit 12Z specifies at least one position in the virtual space as the second position (for example, the position in the group region of the monsters) in accordance with the second rule different from the first rule; the arranging unit 13Z arranges the predetermined object (for example, the enemy character object or the group character object) at any or both of the first position and the second position; and the occurring unit 14Z causes the event corresponding to the object (for example, the battle event against the enemy character) to occur in accordance with the positional condition regarding the position in the virtual space corresponding to the positional information of the user terminal 20 and the position of the arranged object. Therefore, it becomes possible to maintain interest of the user in the video game.

Further, in the example of the fifth embodiment described above, the server 10Z as the arranging unit 13Z arranges an object defined as an object to be at least arranged at the second position as the predetermined object. Therefore, it is possible to cause the object arranged at the second position to have a feature, and this makes it possible to maintain interest of the user in the video game.

Further, in the example of the fifth embodiment described above, the server 10Z as the arranging unit 13Z arranges the plurality of objects at any or both of the first position and the second position; and the server 10Z as the occurring unit 14Z restricts, in a case where the event corresponding to the object occurs, occurrence of the event corresponding to the predetermined object satisfying the restriction condition of the plurality of arranged objects until the waiting time, which is different from each other between a case where the predetermined object is at least arranged at the first position and a case where the predetermined object is arranged at the second position, elapses after occurrence of the event. Therefore, compared with a case where the waiting time is substantially the same as each other between a case where the object is arranged at the first position and a case where the object is arranged at the second position, it is possible to cause timing to occur an event and a way to cause a video game to proceed by the user to have variation. This makes it possible to maintain interest of the user in the video game.

Further, in the example of the fifth embodiment described above, the server 10Z as the updating unit 15Z updates, when the event corresponding to the second arranged object is caused to occur, the information regarding the user (for example, the energy of the metal radar) on the basis of the occurrence situation of the event corresponding to the second arranged object; and the server 10Z as the occurring unit 14Z restricts occurrence of the event corresponding to the second arranged object on the basis of the information regarding the user. Therefore, when the event corresponding to the second arranged object is caused to occur, it is possible to make the user aware of the occurrence situation of the event corresponding to the second arranged object more strongly, and it is also possible to improve diversity of progress of the event. As a result, it becomes possible to further improve interest of the user in the video game.

Further, it has not been mentioned particularly in the example of the fifth embodiment described above. However, the server 10Z may be configured so as to: refer to a storage unit, in which the second position, at least one of a plurality of regions provided in the virtual space, and the information regarding the user are stored so as to be associated with each other, to update the information regarding the user corresponding to the second position, at which the second arranged object corresponding to the event is arranged, on the basis of the occurrence situation of the event; and restrict the occurrence of the event corresponding to the second arranged object arranged at the second position on the basis of the information regarding the user corresponding to the second position. Namely, the server 10Z may be configured so as to restrict, for each of the second positions, the occurrence of the event corresponding to the second arranged object arranged at the second position on the basis of the information regarding the user corresponding to the second position.

Here, it has not been mentioned particularly in the example of the fifth embodiment described above. However, a configuration to associate the second position, at least one of the plurality of regions provided in the virtual space, and the information regarding the user with each other is not limited particularly. However, for example, the server 10Z may be configured so that the plurality of second positions, one region, and one piece of information regarding the user are associated with each other. Namely, in the example described above, the server 10Z may be configured so that the position of the metallic monster, the group region of the monsters, and the defeatable number of metallic monsters in the group region of the monsters are associated with each other. Namely, the server 10Z may be configured so that in a case where a plurality of group regions of the monsters is displayed for one user, each of the group regions of the monsters, and the defeatable number of metallic monsters are associated with each other. By causing the server 10Z to have such a configuration, it is possible to encourage the user to move to a plurality of regions, and this makes it possible to improve interest of the user in the video game.

Further, it has not been mentioned particularly in the example of the fifth embodiment described above. However, a configuration to restrict occurrence of the event corresponding to the second arranged object arranges at the second position on the basis of the information regarding the user corresponding to the second position is not limited particularly. For example, in the example described above, the server 10Z may be configured so that display of the group of monsters is terminated for the user for which the defeatable number of metallic monsters in one group of monsters becomes zero. In this case, the server 10Z may be configured so that display of the other group of monsters is also terminated for such a user. By causing the server 10Z to have such a configuration, in a case where occurrence of the event corresponding to the object arranged at the second position corresponding to any region of the plurality of regions provided in the virtual space is restricted, it is possible to encourage the user to occur an event in the other region thereof. Namely, it becomes possible to encourage the user to move in the real space when the event corresponding to the second arranged object is caused to proceed.

Further, it has not been mentioned particularly in the example of the fifth embodiment described above. However, the server 10Z may be configured so as to refer to a storage unit, in which the second position, at least one of a plurality of regions provided in the virtual space, and a region restriction condition are stored so as to be associated with each other, to restrict the occurrence of the event corresponding to the second arranged object arranged at the second position corresponding to the region restriction condition in a case where the occurrence situation of the event corresponding to the second arranged object satisfies the region restriction condition corresponding to the second position at which the second arranged object is arranged.

Here, it has not been mentioned particularly in the example of the fifth embodiment described above. However, the region restriction condition means a condition of an occurrence situation of an event to restrict the occurrence of the event corresponding to the second arranged object arranged at the corresponding second position. The region restriction condition is not limited particularly. However, it is preferable that the region restriction condition is a condition regarding an occurrence situation of an event corresponding to an object arranged at a corresponding second position. As an example of the region restriction condition, there is a condition in which an occurrence situation of a battle event corresponding to an enemy character object arranged at the second position is a situation that “the user character defeats a predetermined type of enemy character”. For example, in the example described above, the server 10Z may be configured so that in a case where the user character defeats a specific monster in a battle event against one group of monsters, display of the one group of monsters in which the specific monster appeared is terminated. By causing the server 10Z to have such a configuration, it is possible to encourage the user to cause another event to occur in another region after the region restriction condition is satisfied. Therefore, it is possible to give diversity to progress of the video game, and this makes it possible to further maintain interest of the user in the video game. In this regard, the server 10Z may be configured so that in a case where a plurality of second positions is set, different region restriction conditions are respectively associated with the second positions. By causing the server 10Z to have such a configuration, it is possible to further give diversity to progress of the video game.

Further, it has not been mentioned particularly in the example of the fifth embodiment described above. However, the server 10Z may be configured so as to update the information regarding the user in a case where an occurrence situation of event (hereinafter, referred to as a “first arrangement event”) corresponding to an object arranged at the first position satisfies an update condition of the information regarding the user. Here, the update condition means a condition regarding an occurrence situation of the first arrangement event to determine whether the information regarding the user is to be updated or not. The update condition is not limited particularly. However, it is preferable that the update condition is a condition in which an occurrence situation of an event is related to a type of a second arranged object. As an example of the update condition, there is a condition in which the occurrence situation of the first arrangement event is related to the second arranged object. In the present embodiment, the update condition is a condition that a metallic monster is defeated in a battle event against an enemy character object other than the group of monsters. By causing the server 10Z to have such a configuration, it is also necessary for the user to consider occurrence of the event corresponding to the second arranged object when the first arrangement event is caused to proceed. Therefore, it is possible to give diversity to progress of the video game, and this makes it possible to further maintain interest of the user in the video game.

Further, it has not been mentioned particularly in the example of the fifth embodiment described above. However, the server 10Z may be configured so as to maintain the information regarding the user in a case where the occurrence situation of the first arrangement event satisfies the update condition and satisfies a first maintenance condition of the information regarding the user. Here, the first maintenance condition means a condition regarding the occurrence situation of the first arrangement event to maintain the information regarding the user regardless of the update condition. The first maintenance condition is not limited particularly. However, it is preferable that the server 10Z is configured so that the user can recognize that the occurrence situation of the first arrangement event satisfies the first maintenance condition before occurrence of the first arrangement event. As an example of the first maintenance condition, there is a condition that an event corresponding to an object arranged at a predetermined first position specified as the first position occurs. Further, the phrase “maintain the information regarding the user” means that a process to update the information regarding the user to the same information as that before update is executed, or that the process to update the information regarding the user is not executed. By causing the server 10Z to have such a configuration, it is possible to further improve diversity of progress of the first arrangement event, and this makes it possible to further maintain interest of the user in the video game.

Further, it has not been mentioned particularly in the example of the filth embodiment described above. However, the server 10Z may be configured so as to maintain the information regarding the user in a case where the occurrence situation of the event corresponding to the second arranged object satisfies a second maintenance condition of the information regarding the user. Here, the second maintenance condition means a condition of the occurrence situation to maintain the information regarding the user with respect to the occurrence situation of the event corresponding to the second arranged object. The second maintenance condition is not limited particularly. However, it is preferable that the second maintenance condition is a condition that is satisfied on the basis of whether the occurrence situation of the event corresponding to the second arranged object is advantageous for progress of the video game by the user or not. As an example of the second maintenance condition, there is a condition that progress of the video game by the user has not been advantageous due to the occurrence of the event corresponding to the second arranged object. In this regard, in the present embodiment, the second maintenance condition is that the occurrence situation of the battle event indicates a metallic monster cannot be defeated in a battle event corresponding to a group character object (for example, the metallic monster escapes or the user character escapes from the metallic monster). Further, in the present embodiment, in a case where the occurrence situation of the battle event satisfies the second maintenance condition, the defeatable parameter is maintained. By causing the server 10Z to have such a configuration, it is possible to cause the user to consider progress of the event corresponding to the second arranged object. As a result, it becomes possible to further maintain interest of the user in the video game.

Further, it has not been mentioned particularly in the example of the fifth embodiment described above. However, in a case where a non-restriction condition is satisfied, the server 10Z may be configured to update the information regarding the user so that the occurrence of the event corresponding to the second arranged object is not restricted. Here, the non-restriction condition means a condition that the occurrence of the event corresponding to the second arranged object is not restricted. The non-restriction condition is not limited particularly. However, it is preferable that the non-restriction condition is a condition that is satisfied regardless of progress of the video game by the user. As an example of the non-restriction condition, there is a condition that a real time or a time in the virtual space becomes a predetermined point of time. In this regard, the server 10Z may be configured to update the information regarding the user so that the occurrence of the event corresponding to the second arranged object is not restricted further (that is, so that a possibility to be restricted is reduced) in a case where the occurrence of the event corresponding to the second arranged object is not restricted and the non-restriction condition is satisfied. By causing the server 10Z to have such a configuration, it is possible to increase the motivation of the user regarding progress of the event corresponding to the second arranged object, and this makes it possible to further maintain interest of the user in the video game.

Further, it has not been mentioned particularly in the example of the firth embodiment described above. However, the server 10Z may be configured so as to cause an event corresponding to the second arranged object and whose content is determined on the basis of the information regarding the user to occur in accordance with the positional condition regarding the user virtual position and the position of the second arranged object. Here, the event whose content is determined on the basis of the information regarding the user means an event whose content varies in accordance with the information regarding the user at the time of occurrence thereof. The event whose content is determined on the basis of the information regarding the user is not limited particularly. However, it is preferable that the event is an event that the user can predict the content thereof on the basis of the information regarding the user. As an example of the event whose content is determined on the basis of the information regarding the user, there is an event whose content is determined from a parameter in a case where the information regarding the user is the parameter that increases or decreases in accordance with progress of the video game. By causing the server 10Z to have such a configuration, the user can be caused to consider an influence on another event of the second arranged object during progress of the event corresponding to the other second arranged object. Therefore, it is possible to improve interest of the user in the video game. As a result, it becomes possible to further maintain interest of the user in the video game.

Further, it has not been mentioned particularly in the example of the fifth embodiment described above. However, the server 10Z may be configured so as to: refer to a storage unit, in which the second position, at least one of the plurality of regions, and an occurrence possible period are stored so as to be associated with each other; restrict occurrence of the event corresponding to the second arranged object arranged at the second position corresponding to the occurrence possible period in a case where the occurrence possible period corresponding to the second position elapses after a predetermined object is arranged at the second position; and cause the user terminal 20 to display information regarding the occurrence possible period. Here, the occurrence possible period means a period during which an event corresponding to an object arranged at the corresponding second position can be caused to occur. The occurrence possible period is not limited particularly. However, it is preferable that the occurrence possible period is a period defined on the basis of the content of the event corresponding to the second arranged object. As an example of the occurrence possible period, there is a period that becomes longer as a degree of difficulty to clear the event corresponding to the object arranged at the corresponding second position increases. Further, the phrase “cause the user terminal 20 to display information regarding the occurrence possible period” means that the user terminal 20 is caused to display information for notifying the user of the occurrence possible period corresponding to the region. A configuration to cause the user terminal 20 to display the information regarding the occurrence possible period is not limited particularly. However, it is preferable that the server 10Z is configured so as to cause the user terminal 20 to display information indicating a correspondence relationship between the occurrence possible period and the region. As an example of the configuration to cause the user terminal 20 to display the information regarding the occurrence possible period, there is a configuration in which the user terminal 20 is caused to display the information indicating the occurrence possible period in the vicinity of a position of the region corresponding to the occurrence possible period in the virtual space. By causing the server 10Z to have such a configuration, it is possible to cause the user to consider how the event corresponding to the second arranged object is caused to proceed in a limited period. Therefore, it is possible to further improve interest of the user in the video game. As a result, it becomes possible to further maintain interest of the user in the video game.

Further, it has not been mentioned particularly in the example of the fifth embodiment described above. However, the server 10Z may be configured so that a plurality of regions is regions each having a predetermined area and randomly provided in the virtual space. Here, the regions each having the predetermined area and randomly provided means regions each having a predetermined area and respectively provided at locations randomly defined in the virtual space. The regions each having the predetermined area and randomly provided are not limited particularly. However, it is preferable that each of the regions is a region in which a situation that a user virtual position is included in the region can occur. As an example of the regions each having the predetermined area and randomly provided, there is a plurality of regions that are provided substantially evenly at intervals of a predetermined distance in the virtual space. By causing the server 10Z to have such a configuration, it is possible to give the user an opportunity to cause the event corresponding to the second arranged object to proceed regardless of the user's living area in the real space compared with a case where a region in the virtual space corresponding to a position of predetermined facility in the real space is provided. As a result, it becomes possible to further maintain interest of the user in the video game.

As explained above, one or two or more shortages can be solved by each or the embodiments according to the present application. In this regard, the effects by each of the embodiments are non-limiting effects or one example of the non-limiting effects.

In this regard, in each of the embodiments described above, each of the plurality of user terminals 20, and 201 to 20N and the server 10 executes the various kinds or processing described above in accordance with various kinds of control programs (for example, a video game processing program) stored in the storage device with which the corresponding terminal or server is provided.

Further, the configuration of the system 100 is not limited to the configuration that has been explained as an example of each of the embodiments described above. For example, the system 100 may be configured so that the server 10 executes a part or all of the processes that have been explained as the processes executed by the user terminal 20. Alternatively, the system 100 may be configured so that any of the plurality of user terminals 20, and 201 to 20N (for example, the user terminal 20) executes a part or all of the processes that have been explained as the processes executed by the server 10. Further, the system 100 may be configured so that a part or all of the storage unit included in the server 10 is included in any of the plurality of user terminals 20, and 201 to 20N. Namely, the system 100 may be configured so that a part or all of the functions of any one of the user terminal 20 and the server 10 according to the system 100 is included in the other.

Further, the system 100 may be configured so that the program causes a single apparatus to perform a part or all of the functions that have been explained as the example of each of the embodiments described above without including a communication network.

### APPENDIX

The explanation of the embodiments described above has been described so that the following embodiments can be at least performed by a person having a normal skill in the art to which the present disclosure belongs.

(1)

A non-transitory computer-readable medium including a video game processing program for causing a server to perform functions to control progress of a video game using positional information of a user terminal in response to an operation of a user, the functions comprising:

a first specifying function configured to specify at least one position in a virtual space as a first position in accordance with a first rule, the virtual space corresponding to map information of a real space;

a second specifying function configured to specify at least one position in the virtual space as a second position in accordance with a second rule different from the first rule;

an arranging function configured to arrange a predetermined object at any or both of the first position and the second position; and

an occurring function configured to cause an event corresponding to an object to occur in accordance with a positional condition regarding a user virtual position in the virtual space corresponding to the positional information of the user terminal and a position of the arranged object.

(2)

The non-transitory computer-readable medium according to (1),

wherein the arranging function includes a function configured to arrange, at the second position as the predetermined object, an object defined as an object to be at least arranged at the second position.

(3)

The non-transitory computer-readable medium according to (1) or (2),

wherein the arranging function includes a function configured to arrange a plurality of objects at any or both of the first position and the second position, and

wherein the occurring function includes a function configured to restrict, in a case where the event corresponding to the object occurs, occurrence of an event corresponding to a predetermined object satisfying a restriction condition of the plurality of objects arranged by the arranging function until a waiting time elapses after the event occurs, the waiting time in a case where the predetermined object is at least arranged at the first position being different from the waiting time in a case where the predetermined object is arranged at the second position.

(4)

The non-transitory computer-readable medium according to any one of (1) to (3), the functions further comprising:

an updating function configured to update information regarding the user on a basis of an occurrence situation of the event corresponding to the object arranged at the second position as a second arranged object,

wherein the occurring function includes a function configured to restrict occurrence of the event corresponding to the second arranged object on a basis of the information regarding the user.

(5)

The non-transitory computer-readable medium according to (4),

wherein the updating function includes a function configured to refer to a storage unit, in which the second position, at least one of a plurality of regions provided in the virtual space, and the information regarding the user are stored so as to be associated with each other, to update the information regarding the user corresponding to the second position, at which the second arranged object corresponding to the event is arranged, on the basis of the occurrence situation of the event, and

wherein the occurring function includes a function configured to restrict the occurrence of the event corresponding to the second arranged object arranged at the second position on the basis of the information regarding the user corresponding to the second position.

(6)

The non-transitory computer-readable medium according to (4) or (5),

wherein the occurring function includes a function configured to refer to a storage unit, in which the second position, at least one of a plurality of regions provided in the virtual space, and a region restriction condition are stored so as to be associated with each other, to restrict the occurrence of the event corresponding to the second arranged object arranged at the second position corresponding to the region restriction condition in a case where the occurrence situation of the event corresponding to the second arranged object satisfies the region restriction condition corresponding to the second position at which the second arranged object is arranged.

(7)

The non-transitory computer-readable medium according to any one of (4) to (6),

wherein the updating function includes a function configured to update the information regarding the user in a case where an occurrence situation of an event corresponding to an object arranged at the first position satisfies an update condition of the information regarding the user.

(8)

The non-transitory computer-readable medium according to (6) or (7),

wherein the updating function includes a function configured to maintain information regarding the user in a case where an occurrence situation of an event corresponding to an object arranged at the first position satisfies an update condition and a first maintenance condition of the information regarding the user.

(9)

The non-transitory computer-readable medium according to any one of (4) to (8),

wherein the updating function includes a function configured to maintain the information regarding the user in a case where the occurrence situation of the event corresponding to the second arranged object satisfies a second maintenance condition of the information regarding the user.

(10)

The non-transitory computer-readable medium according to any one of (4) to (9),

wherein the updating function includes a function configured to update, in a case where a non-restriction condition is satisfied, the information regarding the user so that the occurrence of the event corresponding to the second arranged object is not restricted.

(11)

The non-transitory computer-readable medium according to any one of (4) to (10),

wherein the occurring function includes a function configured to cause an event that corresponds to the second arranged object and whose content is defined on the basis of the information regarding the user to occur in accordance with the positional condition regarding the user virtual position and a position of the second arranged object.

(12)

The non-transitory computer-readable medium according to (5) or (6),

wherein the occurring function includes a function configured to refer to a storage unit, in which the second position, at least one of the plurality of regions, and an occurrence possible period are stored so as to be associated with each other, to restrict the occurrence of the event corresponding to the second arranged object arranged at the second position corresponding to the occurrence possible period in a case where the occurrence possible period corresponding to the second position elapses after the predetermined object is arranged at the second position, and

wherein the functions further comprise a displaying function configured to cause the user terminal to display information regarding the occurrence possible period.

(13)

The non-transitory computer-readable medium according to (5) or (6),

wherein each of the plurality of regions is a region with a predetermined area, which is randomly provided in the virtual space.

(14)

A non-transitory computer-readable medium including a video game processing program for causing a user terminal to perform at least one function of the functions that the video game processing program described in any one of (1) to (13) causes the server to perform, the user terminal being capable of communicating with the server.

(15)

A server into which the video game processing program described in any one of (1) to (15) is installed.

(16)

A video game processing system for controlling progress of a video game using positional information of a user terminal in response to an operation of a user, the video game processing system comprising a communication network, a server, and a user terminal, the video game processing system further comprising:

a first specifying unit configured to specify at least one position in a virtual space as a first position in accordance with a first rule, the virtual space corresponding to map information of a real space;

a second specifying unit configured to specify at least one position in the virtual space as a second position in accordance with a second rule different from the first rule;

an arranging unit configured to arrange a predetermined object at any or both of the first position and the second position; and

an occurring unit configured to cause an event corresponding to an object to occur in accordance with a positional condition regarding a user virtual position in the virtual space corresponding to the positional information or the user terminal and a position of the arranged object.

(17)

The video game processing system according to (16),

wherein the server includes the first specifying unit, the second specifying unit, the arranging unit, and the occurring unit, and

wherein the user terminal includes an outputting unit configured to output a game screen to a display screen of a display device, the game screen indicating a state of the predetermined object.

(18)

A non-transitory computer-readable medium including a video game processing program for causing a user terminal to perform functions to control progress of a video game using positional information of the user terminal in response to an operation of a user, the functions comprising:

a first specifying function configured to specify at least one position in a virtual space as a first position in accordance with a first rule, the virtual space corresponding to map information of a real space;

a second specifying function configured to specify at least one position in the virtual space as a second position in accordance with a second rule different from the first rule;

an arranging function configured to arrange a predetermined object at any or both of the first position and the second position; and

an occurring function configured to cause an event corresponding to an object to occur in accordance with a positional condition regarding a user virtual position in the virtual space corresponding to the positional information of the user terminal and a position of the arranged object.

(19)

A video game processing method of controlling progress of a video game using positional information of a user terminal in response to an operation of a user, the video game processing method comprising:

a first specifying process configured to specify at least one position in a virtual space as a first position in accordance with a first rule, the virtual space corresponding to map information of a real space;

a second specifying process configured to specify at least one position in the virtual space as a second position in accordance with a second rule different from the first rule;

an arranging process configured to arrange a predetermined object at any or both of the first position and the second position; and

an occurring process configured to cause an event corresponding to an object to occur in accordance with a positional condition regarding a user virtual position in the virtual space corresponding to the positional information of the user terminal and a position of the arranged object.

(20)

A video game processing method of controlling progress of a video game using positional information of a user terminal in response to an operation of a user by a video game processing system, the video game processing system including a communication network, a server, and a user terminal, the video game processing method comprising:

a first specifying process configured to specify at least one position in a virtual space as a first position in accordance with a first rule, the virtual space corresponding to map information of a real space;

a second specifying process configured to specify at least one position in the virtual space as a second position in accordance with a second rule different from the first rule;

an arranging process configured to arrange a predetermined object at any or both of the first position and the second position; and

an occurring process configured to cause an event corresponding to an object to occur in accordance with a positional condition regarding a user virtual position in the virtual space corresponding to the positional information or the user terminal and a position of the arranged object.

### INDUSTRIAL APPLICABILITY

According to one of the embodiments of the present disclosure, it is useful to allow interest of a user in a video game to be maintained.

What is claimed is:

1. A non-transitory computer-readable medium storing a video game processing program for causing a computer of a server to perform functions to control progress of a video game using positional information of a user terminal in response to an operation of a user, the functions comprising:
specifying at least one position in a virtual space as a first position in accordance with a first rule, the virtual space corresponding to map information of a real space;
specifying at least one position in the virtual space as a second position in accordance with a second rule different from the first rule;
arranging a predetermined object at least one of or both of the first position or the second position; and
causing an event corresponding to an object to occur in accordance with a positional condition regarding a user virtual position in the virtual space corresponding to the positional information of the user terminal and a position of the arranged object.

2. The non-transitory computer-readable medium according to claim 1,
wherein arranging the predetermined object includes arranging an object defined to be at least arranged at the second position as the predetermined object at the second position.

3. The non-transitory computer-readable medium according to claim 1,
wherein arranging the predetermined object includes arranging a plurality of objects at any or both of the first position and the second position, and
wherein causing the event corresponding to the object to occur includes, when the event corresponding to the object occurs, restricting occurrence of an event corresponding to a predetermined object satisfying a restriction condition of the plurality of arranged objects until a waiting time elapses after the event occurs, wherein the waiting time when the predetermined object is at least arranged at the first position is different from the waiting time when the predetermined object is arranged at the second position.

4. The non-transitory computer-readable medium according to claim 1, the functions further comprising:
updating information regarding the user on a basis of an occurrence situation of the event corresponding to a second arranged object that is the object arranged at the second position as,
wherein causing the event corresponding to the object to occur includes restricting occurrence of the event corresponding to the second arranged object on a basis of the information regarding the user.

5. The non-transitory computer-readable medium according to claim 4,
wherein updating the information regarding the user includes:
referring to a storage unit that is configured to store the second position, at least one of a plurality of regions provided in the virtual space and the information regarding the user associated with one another; and
updating the information regarding the user corresponding to the second position where the second arranged object corresponding to the event is arranged, on the basis of the occurrence situation of the event, and
wherein causing the event corresponding to the object to occur includes restricting the occurrence of the event corresponding to the second arranged object on the basis of the information regarding the user corresponding to the second position.

6. The non-transitory computer-readable medium according to claim 4,
wherein causing the event corresponding to the object to occur includes:
referring to a storage unit that is configured to store the second position, at least one of a plurality of regions provided in the virtual space and a region restriction condition associated with one another; and
restricting the occurrence of the event corresponding to the second arranged object corresponding to the region restriction condition when the occurrence situation of the event corresponding to the second arranged object satisfies the region restriction condition corresponding to the second position.

7. The non-transitory computer-readable medium according to claim 4,
wherein updating the information regarding the user is performed when an occurrence situation of an event corresponding to an object arranged at the first position satisfies an update condition of the information regarding the user.

8. The non-transitory computer-readable medium according to claim 6,
wherein updating the information regarding the user includes maintaining information regarding the user when an occurrence situation of an event corresponding to an object arranged at the first position satisfies an update condition and a first maintenance condition of the information regarding the user.

9. The non-transitory computer-readable medium according to claim 4,
wherein updating the information regarding the user includes maintaining the information regarding the user when the occurrence situation of the event corresponding to the second arranged object satisfies a second maintenance condition of the information regarding the user.

10. The non-transitory computer-readable medium according to claim 4,
wherein updating the information regarding the user includes updating, when a non-restriction condition is satisfied, the information regarding the user not to restrict the occurrence of the event corresponding to the second arranged object.

11. The non-transitory computer-readable medium according to claim 4,
wherein causing the event corresponding to the object to occur further includes causing an event to occur in accordance with the positional condition regarding the user virtual position and the second position,
wherein the event corresponds to the second arranged object and has content defined on the basis of the information regarding the user.

12. The non-transitory computer-readable medium according to claim 5,
wherein causing the event corresponding to the object to occur further comprises:
referring to a storage unit that is configured to store the second position, at least one of the plurality of regions, and an occurrence possible period associated with one another;
restricting the occurrence of the event corresponding to the second arranged object corresponding to the occurrence possible period when the occurrence possible period corresponding to the second position elapses after the predetermined object is arranged at the second position; and
causing the user terminal to display information regarding the occurrence possible period.

13. The non-transitory computer-readable medium according to claim 5,
wherein each region of the plurality of regions is a region with a predetermined area randomly provided in the virtual space.

14. A video game processing system for controlling progress of a video game, comprising:
a communication network;
a server;
a user terminal; and
a computer configured to:
specify at least one position in a virtual space as a first position in accordance with a first rule, the virtual space corresponding to map information of a real space;
specify at least one position in the virtual space as a second position in accordance with a second rule different from the first rule;
arrange a predetermined object at least one of or both of the first position and the second position; and
cause an event corresponding to an object to occur in accordance with a positional condition regarding a user virtual position in the virtual space corresponding to the positional information of the user terminal and a position of the arranged object.

15. A non-transitory computer-readable medium including a video game processing program for causing a computer of a user terminal to perform functions to control progress of a video game using positional information of the user terminal in response to an operation of a user, the functions comprising:
specifying at least one position in a virtual space as a first position in accordance with a first rule, the virtual space corresponding to map information of a real space;
specifying at least one position in the virtual space as a second position in accordance with a second rule different from the first rule;
arranging a predetermined object at least one of or both of the first position and the second position; and
causing an event corresponding to an object to occur in accordance with a positional condition regarding a user virtual position in the virtual space corresponding to the positional information of the user terminal and a position of the arranged object.
